(19) United States
(12) Patent Application Publication
(10) Pub. No.: US 2010/0132816 A1
(43) Pub. Date: Jun. 3, 2010

(54) CHECK VALVE FOR A HYDRAULIC POWER-ASSISTED STEERING SYSTEM

(75) Inventors: Peter Hölzle, Wernau (DE); Roger Kollmeier, Stuttgart (DE); Niels Worringen, Esslingen (DE)

Correspondence Address: CONNOLLY BOVE LODGE & HUTZ LLP, 1875 EYE STREET, N.W., SUITE 1100, WASHINGTON, DC, 20006, US

(73) Assignee: ThyssenKrupp Presta AG, Eschen (LI)

(21) Appl. No.: 12/620,072

(22) Filed: Nov. 17, 2009

(30) Foreign Application Priority Data
Dec. 3, 2008 (DE) 10 2008 060 146.2

(51) Int. Cl. F16K 15/02

(52) U.S. Cl. 137/535

(57) ABSTRACT

The invention relates to a check valve for a hydraulic power-assisted steering system, with a valve housing, into which a movable valve member is inserted, wherein the valve member interacts with sealing effect with a valve seat, and has lateral guide elements for guiding the valve member in the valve housing, wherein the movable valve member is a shaped metal part with uniform wall thickness and at least three guide elements having a constant width in the circumferential direction.

The present invention relates to a check valve with the features of the preamble of Claim 1.

In hydraulic power-assisted steering systems for motor vehicles, a hydraulic servo motor acts on a steering gear system. During travel, road influences exert forces which the steered wheels cause to have a reciprocal effect on the steering system. These reciprocal effects are expressed as pressure pulses in the hydraulic system.

In order to keep these pressure pulses, which act against the normal direction of flow of the hydraulic fluid, away from other components such as, for example, the hydraulic pump, check valves are known between the hydraulic servo drive and the hydraulic pump.

Such a check valve is represented in U.S. Pat. No. 7,428,945 B2. The check valve has a housing with a valve seat, into which housing a movable valve member is inserted. The movable valve member carries a central valve member, which interacts with sealing effect with the valve seat, as well as three lateral guide surfaces for guiding the valve member, which can be displaced in the axial direction, in the valve housing. A helical spring is arranged centrally and coaxially to the axis of symmetry of the valve, which helical spring pre-tensions the valve into the closed position.

The movable valve member is of complex design. It has a geometrical shape between the central valve body and the guide surfaces which is intended to impose as little resistance as possible to the hydraulic flow. The spring for pre-tensioning the valve member into the closed position is subjected to the hydraulic flow without a specific guide arrangement. This design is therefore relatively elaborate, and in operation is subject to deformation of the helical spring.

The check valve disclosed in U.S. Pat. No. 3,157,191 is similarly complex. In this case, the helical spring is guided via a centrally arranged trunnion, and is therefore largely protected against deformation. On the low-pressure side, however, the valve is to a large extent open to the side, in other words in the radial direction transverse to the flow. This valve cannot be readily inserted into housing passage apertures or connection apertures for hydraulic lines.

Finally, DE 29 41 244 C2 shows a check valve which carries openings on the low-pressure side located downstream which point only in the axial direction, such that this valve can be inserted into passage openings and line connection openings. The helical spring is also guided by a trunnion. However, the helical spring stands up in the area of the passage openings on the base surface facing away from the valve member, and may therefore, at high fluid speeds, become deformed in this area, and be pressed into one of the openings.

It is therefore the object of the present invention to provide a check valve for a hydraulic power steering system which is flowed through only in the axial direction, and which is easier to manufacture and less prone to failure in operation.

This object is resolved by a check valve with the features of Claim 1.

Because the check valve is designed to be essentially rotationally symmetrical, and a trunnion is arranged centrally beneath the movable valve member, which trunnion delimits the stroke of the valve member, the contact stop of the valve in the open state does not occur in the area of the guide surfaces but centrally in the area of the section of the valve member which interacts with the valve seat. Tilt movements and deformations of the valve member in the area of the guide surfaces are thereby excluded. In addition, the valve can be readily inserted into passage openings, because the outflow openings in the base, designed as a base plate, are open only in the axial direction of the valve. Finally, even under high fluid speeds, deformation of the helical spring into one of the outflow openings is excluded, because the sections of the base forming the outflow openings are arranged outside the contact surface of the helical spring.

If, moreover, the movable valve member is a metal shaped part with uniform wall thickness and at least two guide sections having a constant width in the circumferential direction, then this valve member can be manufactured as a punched and bent part. Other alternative materials can also be used for the valve member, such as suitable plastics or composite materials, taking into consideration economical manufacturing processes.

If, moreover, a helical spring is provided for the resetting of the valve member into the closed position, which surrounds the trunnion with little play, the helical spring is guided almost over its entire length when the check valve is open. Deformations of the helical spring due to the hydraulic flow are therefore also excluded.

If the trunnion is, connected as one piece to an essentially triangular base plate, and this base plate is secured in the valve housing, a large flow cross-section is possible laterally, next to the base plate in the valve housing. The valve housing can in this situation be a sheet metal component, which in the area of the base plate secures the base plate permanently by shaping. One particularly advantageous configuration makes provision for the moving valve member to have four guide surfaces, which are divided uniformly over the circumference at an angle interval of 90° in each case in relation to the axis of symmetry.

Finally, it is advantageous if, when the check valve is closed, the clear interval between the central area of the valve member and the trunnion is less than the interval between the free ends of the guide surfaces of the base plate, such that the contact stop of the valve in the opening direction does not take place in the area of the guide surfaces.

An embodiment of the present invention is described hereinafter on the basis of the drawings. These show:

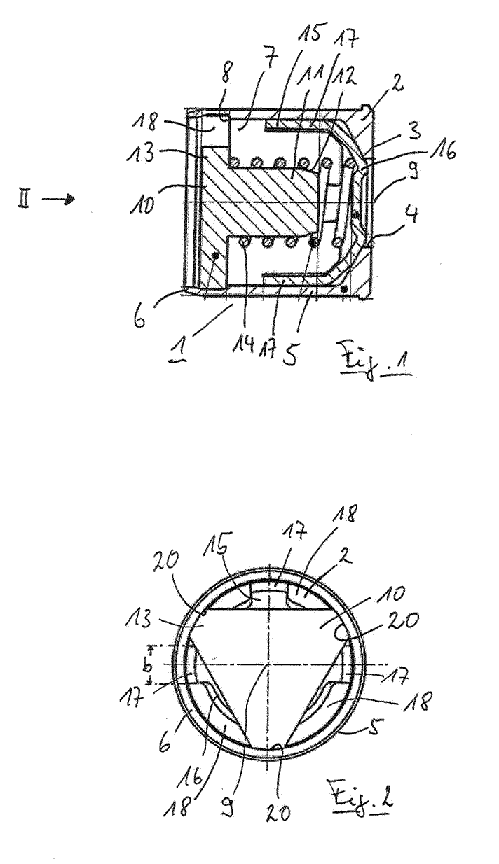

FIG. 1: A check valve according to the invention in a longitudinal section; and

FIG. 2: The valve from FIG. 1 in a view from the front, against the direction of flow.

FIG. 1 shows a check valve 1 with a rotationally symmetrical basic body as valve housing 2, which basic body can be manufactured, for example, as a rotational part. The valve housing 2 has a front surface 3 facing the main direction of flow, into which a central opening 4 is introduced. The valve housing 2 further has a wall 5, which is designed to be cylindrical. A free end 6 is provided for opposite the face side 3. The valve housing 2 surrounds an interior space 7, which is surrounded by the wall 5. Starting from the front face 3, the wall 5 initially has a cross-section with constant thickness. Facing the free end 6, the cross-section is enlarged from the inside, such that an annular collar 8 is produced in the transition area from the smaller free cross-section to the larger free cross-section. In the area of the larger free cross-section the wall thickness of the wall 5 is reduced.

The valve housing is designed to be rotationally symmetrical to an axis 9.

A guide element 10 is inserted into the valve housing 2. The guide element 10 comprises a trunnion 11, facing the opening 4, which trunnion is arranged concentrically to the axis 9. At its free end the trunnion 11 has a tapering 12. The end of the trunnion 11 facing the opening 4 is designed to be flat and parallel to the face side 3 of the valve housing 2. On the side facing the free end 6 of the valve housing 2, the guide element 10 has a base 13, which is designed in a plate shape. The base 13 is designed as approximately triangular with rounded corners. The trunnion 11 is arranged centrally on the base 13, and in this embodiment is designed as one piece with the base 13.

The trunnion 11 of the guide element 10 is surrounded concentrically by a helical spring 14. The helical spring 14 is located on one side on the base 13 of the guide element 10. It extends away from the base 13 around the trunnion and out over the free end of the trunnion 11 as far as a movable valve member 15. The movable valve member 15 is designed as a punched and bent part and has a central area 16, which in the closed position represented is in contact with sealing effect with the edge of the opening 4. Starting from the central area 16, a total of four guide elements 17 are provided for, which are designed as tabs, and which have a uniform constant width in the circumferential direction. The guide elements 17 are in contact with their outer sides as guide surfaces on the inner side of the wall 5 of the valve housing 2. The valve member 15 also abuts, with its central area 16 on the side facing away from the opening 4, on the helical spring 14. The helical spring 14 therefore pre-tensions the valve member 15 against the edge of the opening 4, and therefore into the closed position. The valve member 15 is arranged against the force of the helical spring 14 in the interior 7 of the valve housing 2, displaceable in the direction of the axis 9.

FIG. 2 shows the check valve 1 from FIG. 1 in a front view, in the direction of the arrow II from FIG. 1. The same structural elements bear the same reference numbers.

In this representation the approximately triangular shape of the base 13 of the guide element 10 is made clear. The base 13 has rounded corners 20, which in their radius are adapted to the inner cross-section of the valve housing 2 in the area of the free end 6. To secure the base 13 in the valve housing 2, the edge of the free end 6, which edge projects beyond the base 13 and is tapered in cross-section, is shaped inwards onto the axis 9. The base 13 abuts, in the area of the rounded corners 20, on the outside on the valve housing 2. In the axial direction, it is secured permanently and immovably, on the one side by the annular collar 8 of the valve housing 2, and on the other side by the shaped edge.

The movable valve member 15 with the tab-shaped guide elements 17 is, as represented in FIG. 2, likewise arranged concentrically to the axis 9. The guide elements 17 have a constant width in the circumferential direction, which width is designated by b. For better guidance of the valve member 15 in the direction of the axis 9, the guide elements 17 are designed as convex in the contact area with the inner side of the wall 5, and have the same radius of curvature, which the wall 5 also carries on its inner side.

In operation, the check valve 1 is installed in a known manner in the hydraulic line between a servo pump and a servo valve. The hydraulic flow impacts from the front side 3 onto the check valve 1, and opens the valve against the resetting force of the helical spring 14 by raising the movable valve member 15 from the edge of the opening 4 which forms the valve seat. The hydraulic fluid can then flow by, in FIG. 1, from the right through the opening 4 to the central section 16 of the valve member 15. The hydraulic fluid then enters the interior 7 of the valve housing 2 between the guide elements 17, and exits the valve housing 2 again through the free areas next to the triangular base 13 in the area of the free end 6. With a powerful hydraulic flow, the valve member 15 is limited in its stroke by the guide element 10. The helical spring 14 then lies in its full length on the trunnion 11 of the guide element 10. Even turbulent rapid flows of hydraulic fluid cannot then deform the helical spring 14. The movable valve member 15 is also designed as very stable due to its design of the guide elements 17 with constant width b, and is insensitive to deformation.

The outflow openings 18 are designed as approximately triangular sections in the base 13. They are only open in the axial direction of the valve, in order for a simple arrangement of the valve in a passage opening or even in a hydraulic line itself to be possible. The sections in the base 13 forming the outflow openings 18 are arranged outside the contact surface of the helical spring 14, so that the helical spring 14 may not be deformed under the dynamic pressure of the flowing hydraulic fluid flowing into one of the outflow openings 18, or even pass through this opening into the part of the hydraulic system located downstream.

If the interval between the free end of the trunnion 11 and the central area 16 is smaller than the interval between the guide elements 17 and the base 13, then a contact stop of the movable valve member 15 occurs centrally, relieving the free ends of the guide surfaces 17. The guide surfaces 17 are then also not permanently deformed.

A pressure pulse taking effect in the opposite direction carries the movable valve member 15 with it, and so closes the opening 4. A reciprocal effect of such a pressure pulse on the hydraulic pump is thereby minimised.

### REFERENCE NUMBER LIST

1. Check valve

2. Valve housing

3. Front surface

4. Opening

5. Wall

6. Free end

7. Interior

8. Annular collar

9. Axis

10. Guide element

11. Trunnion

12. Tapering

13. Base

14. Helical spring

15. Valve member

16. Central area

17. Tab-shaped guide elements

18. Outflow openings

20. Corners

1. A check valve for a hydraulic power-assisted steering system, with a valve housing, into which a movable valve member is inserted, wherein:
the valve member interacts with sealing effect with a valve seat and has lateral guide elements for guiding the valve member in the valve housing,
a base is provided, which carries outflow openings located downstream of the valve member and a trunnion arranged centrally in the direction of flow beneath the movable valve member, which trunnion delimits the stroke of the valve member, and
a helical spring is arranged centrally and coaxially to an axis of symmetry of the check valve, which helical spring pre-tensions the check valve into the closed position, wherein
the outflow openings in the base are open only in the axial direction of the valve, and that the sections of the base forming the outflow openings are arranged outside the contact surface of the helical spring.

2. The check valve according to claim 1, wherein the movable valve member is a metal shaped part with at least two guide elements having a constant width in the circumferential direction.

3. The check valve according to claim 1, wherein the helical spring surrounds the trunnion with little play.

4. The check valve according to claim 1, wherein, when the check valve is open, the helical spring is guided almost over its entire length by the trunnion.

5. The check valve according to claim 1, wherein the trunnion is connected as one piece to a base, and the base is secured in the valve housing in such a way that a free flow cross-section is formed laterally next to the base in the valve housing.

6. The check valve according to claim 1, wherein the base is permanently secured in the valve housing by the shaping of the valve housing.

7. The check valve according to claim 1, wherein the movable valve member has four guide surfaces, which are divided uniformly over the circumference at an angle interval of 90° in each case.

8. The check valve according to claim 1, wherein, when the check valve is closed, the interval between the central area of the valve member and the trunnion is less than the interval between the free ends of the guide surfaces of the base, such that the contact stop of the valve member in the opening direction does not take place in the area of the guide elements.
